(19) United States
(12) Patent Application Publication
(10) Pub. No.: US 2012/0281869 A1
(43) Pub. Date: Nov. 8, 2012

(54) SPEAKER AND ACOUSTIC EQUIPMENT INCLUDING THE SPEAKER

(76) Inventors: Hiroyuki Takewa, Osaka (JP); Shinya Kagawa, Mie (JP)

(21) Appl. No.: 13/520,200

(22) PCT Filed: Nov. 9, 2011
(86) PCT No.: PCT/JP2011/006277

§ 371 Date: Jul. 2, 2012

(30) Foreign Application Priority Data
Nov. 10, 2010 (JP) 2010=252262

(51) Int. Cl. H04R 9/06

(52) U.S. Cl. 381/398

(57) ABSTRACT

A speaker (100, 200) including: a magnetic circuit (120, 220); a frame (103, 203); a coil (109, 210); a diaphragm (101, 201) including a connection portion (102, 202) which connects the diaphragm (101, 201) and the frame (103, 203) to allow the diaphragm (101, 201) to vibrate in a direction vertical to the frame; and a cover member (101, 205) which (i) is disposed to be connected to one end of the frame (103, 203) and to cover the diaphragm (101, 201) from above, and (ii) forms, between the cover member (101, 205) and another end of the frame (103, 203), an opening (130, 230) for emitting a sound, the one and the other ends being in a lateral direction that is orthogonal to the vertical direction, wherein the cover member (101, 205) includes, on a closed end side, a spacer (110, 201) for reducing volumetric capacity of a space on the closed end side above the diaphragm (101, 201) and below the cover member (101, 205).

### TECHNICAL FIELD

The present invention relates to speakers, and particularly to a structure of a chassis of a speaker for achieving a thinner speaker.

### BACKGROUND ART

Recent years have seen a widespread use of what is called a high-definition television, a wide screen television, and the like. With this, more and more televisions have screens having long lateral length. Furthermore, a thin-model television as a whole television set is in demand.

The television is, so to speak, beginning to have a narrower frame due to a thinner television and a chassis around a display having a decreased width. With this, a speaker unit (hereinafter referred to as a “speaker”) used with the thin-model television is required to decrease its width and thickness. At the same time, as the screen shows higher quality images, an output sound is also expected to have higher sound quality.

Other than the speaker for a thin-model television, a speaker for a small-sized wireless unit which is placed in a small space and can emit a sound to the front has been proposed (see Patent Literature (PTL) 1).

In the small-sized wireless unit, a screen and all operation units need to be arranged on a surface of a thin case. Thus, an area that can be used for an emission opening of the speaker is limited to a significantly small area. Moreover, in general, an orientation of a diaphragm needs to be aligned to a surface of the case since the sound is generated due to vibration of the diaphragm. However, it is difficult to make such arrangement due to the above limitations.

In view of this, in the speaker according to PTL 1, in a thin case in which a diaphragm is housed when a speaker is installed in the small-sized wireless unit, a duct that extends in a direction orthogonal to a vibration direction of the diaphragm is formed. A tip of the duct is formed in the emission opening of the sound. This structure enables the sound to be emitted forward through a narrow emission opening.

### CITATION LIST

### Patent Literature

[PTL 1]

Japanese Unexamined Patent Application Publication No. 2001-189981

### SUMMARY OF INVENTION

### [Technical Problem]

However, when the structure described in PTL 1 is applied to a speaker for a television or the like without any modifications, a problem occurs. Specifically, a peak/dip (at least one of a peak and a dip) resulted from a resonance attributed to an acoustic load in a space above a diaphragm occurs in a frequency band from 3 to 10 kHz.

The frequency band from 3 to 10 kHz is a main band that includes a frequency band of a voice and the like. Thus, characteristics as flat as possible are required. In a speaker included in a small-sized wireless unit, volumetric capacity of a space which is above the diaphragm and formed by a case and the diaphragm is small, and a resonance frequency exists in a high band such as 10 kHz or greater. With this, an impact of the peak/dip on the main band is small. In contrast, in a speaker of a television, volumetric capacity of the space above the diaphragm is large. Thus, the resonance frequency drops, and the peak/dip exists in the main band. In other words, the impact of the peak/dip on the main band resulted from the above-described conventional structure is significant.

In view of the above, the present invention has as an object to provide a thin speaker which can achieve, in the main band, flatter sound pressure frequency characteristics than the conventional speaker.

### [Solution to Problem]

In order to solve the aforementioned problem, a speaker according to an aspect of the present invention includes: a magnetic circuit which includes a magnet and a yoke and generates magnetic flux; a frame in which the magnetic circuit is disposed, the frame being an open-topped frame; a coil provided in a magnetic gap of the magnetic circuit; a diaphragm connected to the coil and including a connection portion which connects the diaphragm and the frame to allow the diaphragm to vibrate in a direction vertical to the frame; and a cover member which (i) is disposed to be connected to one end of the frame and to cover the diaphragm from above, and (ii) forms, between the cover member and another end of the frame, an opening for emitting a sound, the one and the other ends being in a lateral direction that is orthogonal to the vertical direction, wherein the cover member includes, on a closed end side that is a side opposite to the opening, a spacer for reducing volumetric capacity of a space on the closed end side above the diaphragm and below the cover member.

With this structure, on the closed end side, the spacer fills predetermined volumetric capacity of the space between the diaphragm and the cover member (a space above the diaphragm). Thus, an acoustic load is reduced. Consequently, peak/dip in a main band is suppressed. This makes it possible to achieve flattening of sound pressure frequency characteristics.

Furthermore, in the speaker according to an aspect of the present invention, the spacer may be provided on a bottom face of the cover member on the closed end side, the spacer projecting downward.

With this structure, for example, volumetric capacity of the space above the diaphragm on the closed end side can be more effectively reduced.

Furthermore, in the speaker according to an aspect of the present invention, the connection portion may be at least partly in an upward projected shape, and the spacer may include a recess on a surface facing the connection portion.

This structure prevents the connection portion from contacting the spacer. At the same time, the volumetric capacity of the space above the diaphragm on the closed end sided can be reduced.

Furthermore, in the speaker according to an aspect of the present invention, the recess may be formed on the spacer by providing, to the spacer, a depression having a shape approximately similar to the upward projected shape of the connection portion.

This structure prevents the connection portion from contacting the spacer. At the same time, the volumetric capacity of a space formed between the diaphragm and the spacer can be minimized. In other words, the space above the diaphragm on the closed end side can be minimized.

Furthermore, in the speaker according to an aspect of the present invention, the spacer may be formed such that a thickness of the spacer in the vertical direction decreases from the closed end side toward the opening.

With this structure, it is possible to more effectively suppress, in the sound pressure frequency characteristics, the peak/dip which occurs due to the acoustic load in the space above the diaphragm.

Furthermore, in the speaker according to an aspect of the present invention, on the closed end side, the space above the diaphragm and below the cover member may have a cross sectional area in the lateral direction less than or equal to 0.9 times a cross sectional area of the space without the spacer.

With this structure, the resonance frequency of the resonance occurring, in the sound pressure frequency characteristics, due to the acoustic load in the space above the diaphragm can be changed to the high frequency side by approximately 10%. Consequently, the dip rises by approximately 3 dB and thus improvement is achieved.

Furthermore, in the speaker according to an aspect of the present invention, the diaphragm may have an effective vibration length less than or equal to 16 mm in the lateral direction.

With this structure, it is possible to prevent, in the sound pressure frequency characteristics, a drop in a sound pressure level in high frequency attributed to directionality.

Furthermore, an acoustic equipment according to an aspect of the present invention includes the speaker according to any one of the aspects described above, wherein the acoustic equipment outputs a sound using the speaker.

With this structure, even in the case of acoustic equipment such as a television in which an emission opening of a sound cannot be provided in a large area in a front face that faces a user, it is possible to provide acoustic equipment which has flatter sound pressure frequency characteristics in a main band than the conventional acoustic equipment.

### [Advantageous Effects of Invention]

According to the present invention, a speaker which has flatter sound pressure frequency characteristics in main band than a conventional speaker, and acoustic equipment which includes the speaker according to the present invention can be provided.

### BRIEF DESCRIPTION OF DRAWINGS

FIG. 1 is a diagram showing a configuration outline of a speaker according to Embodiment 1.

FIG. 2 is a magnified view of the A-A′ cross section of the speaker shown in (b) in FIG. 1.

FIG. 3 is a schematic view showing a structure of acoustic loads of the speaker according to Embodiment 1.

FIG. 4 is a schematic view of a structure of an acoustic tube formed by each of the acoustic loads shown in FIG. 3.

FIG. 5A is a cross sectional view taken along the A-A′ of a speaker which does not include a spacer, and is a diagram showing a simulation analysis model in the case where all of the acoustic loads are taken into consideration.

FIG. 5B is a diagram showing an analysis result of a simulation of an acoustic equivalent circuit in the case where all of the acoustic loads are taken into consideration.

FIG. 6 is a diagram showing an analysis result of a simulation in the case where an acoustic load on a closed end side does not exist.

FIG. 7 is a diagram which shows an analysis result of a simulation of a state in which volumetric capacity of a space on the closed end side is reduced to 90%.

FIG. 8 is a diagram showing another example of a shape of the spacer.

FIG. 9 is a diagram showing a configuration outline of a speaker according to Embodiment 2.

FIG. 10 is a magnified view of the A-A′ cross section of a speaker according to Embodiment 2.

FIG. 11 is a diagram showing examples of various shapes of a spacer according to Embodiment 2.

FIG. 12 is a diagram showing an example of an external appearance of a conventional spacer.

FIG. 13 is a diagram showing an external appearance of the spacer according to Embodiment 2.

FIG. 14 is a diagram showing results of BEM simulation analysis of the conventional spacer and the spacer according to Embodiment 2.

FIG. 15 is a diagram showing sound pressure frequency characteristics of a prototype of the speaker according to Embodiment 2.

FIG. 16 is a diagram showing an external appearance of a television which includes the speaker according to one of Embodiment 1 and Embodiment 2.

### DESCRIPTION OF EMBODIMENTS

Hereinafter, embodiments of the present invention shall be described with reference to the drawings. Note that the same reference numerals are assigned to the same elements and descriptions for them may be omitted.

Furthermore, each of the drawings is not necessarily strictly accurate illustration. Each of the embodiments described below shows a specific, preferable example of the present invention. The numerical values, shapes, structural elements, the arrangement and connection of the structural elements, and the like shown in the following embodiments are given not for limiting the present invention but are merely examples. The scope of the present invention is defined based on the Claims. Therefore, among the structural elements in the following embodiments, structural elements not recited in any one of the independent claims are not necessarily required to solve the problems considered by the present invention but shall be described as structural elements of a preferable embodiment.

### Embodiment 1

The following describes with reference to drawings a speaker 100 according to Embodiment 1.

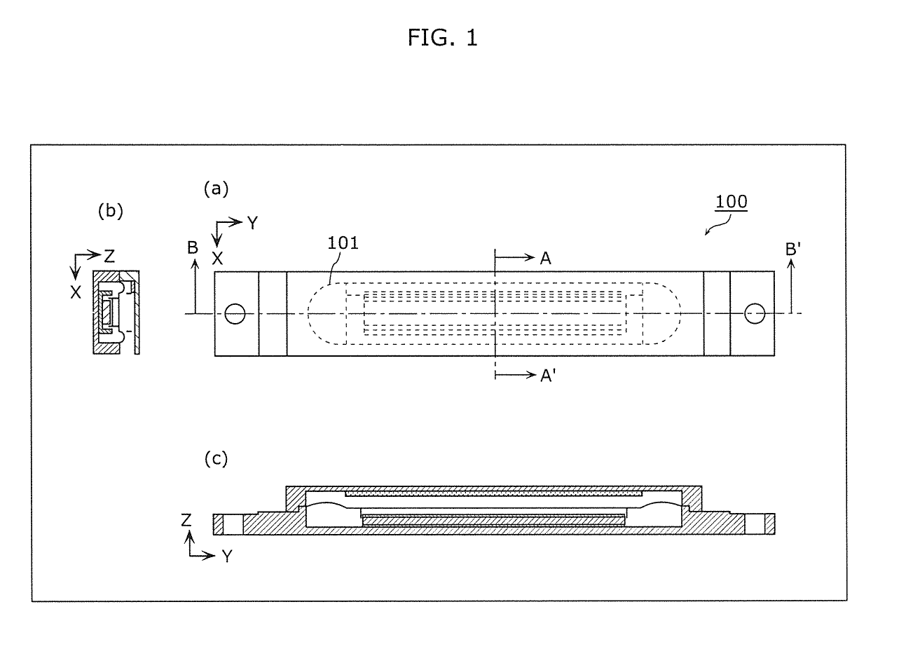

FIG. 1 is a diagram showing a configuration outline of the speaker 100 according to Embodiment 1.

Shown in (a) in FIG. 1 is a top view of the speaker 100, (b) in FIG. 1 shows the A-A′ cross section in (a) in FIG. 1, and (c) in FIG. 1 shows the B-B′ cross section in (a) in FIG. 1.

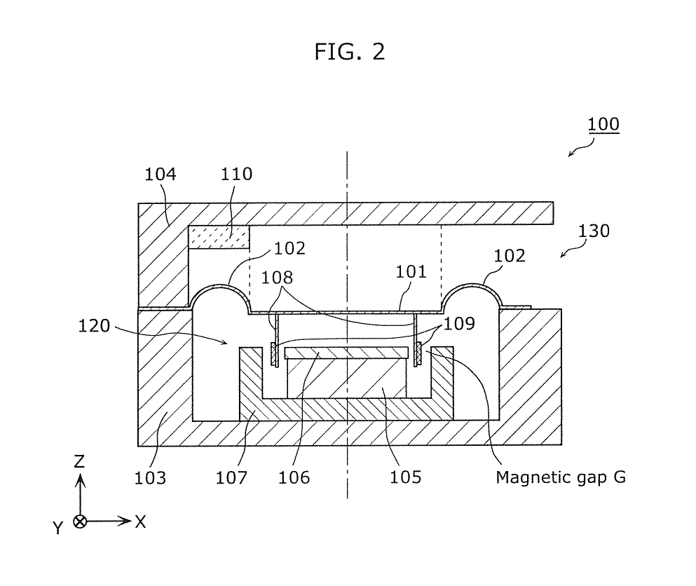

FIG. 2 is a magnified view of the A-A′ cross section of the speaker 100 shown in (b) in FIG. 1.

As shown in FIG. 2, the speaker 100 includes: a diaphragm 101 including a connection portion 102; a frame 103; a cover member 104; a magnetic circuit 120 which includes a magnet 105 and a yoke 107; a voice coil 109; and a spacer 110.

Furthermore, a plate 106 is provided on a top surface of the magnet 105, and the voice coil 109 is connected to the diaphragm 101 through a voice coil bobbin 108.

The diaphragm 101 is placed above the magnetic circuit 120, and has the connection portion 102 which is at least partly in an upward projected shape. Furthermore, each of ends of the diaphragm 101 in a longitudinal direction (Y-axis direction) is in a semicircle or an ellipse shape. The diaphragm 101 is approximately planar and in a shape of a track as a whole.

Furthermore, the diaphragm 101 is in an elongated shape in which a lateral direction (X-axis direction) and a longitudinal direction have mutually different lengths. In this embodiment, for example, the ratio of a lateral direction length and a longitudinal direction length of the diaphragm 101 is approximately 1:7.

Note that although the diaphragm 101 has a planar shape in the above description, shape of a center portion of the diaphragm 101 surrounded by the connection portion 102 is not limited to a planar shape. Instead, the center portion of the diaphragm 101 may be projected or depressed in a dome shape or the entire diaphragm 101 may have ribs that form recesses and projections.

It is preferable that a material of the diaphragm 101 be light weighted and allow the diaphragm 101 to be thin. Although optimal materials are papers, polymeric films, or the like, the material of the diaphragm 101 may be light-weight high rigidity metal foil such as aluminum foil or titanium foil.

The connection portion 102 connects the diaphragm 101 and the frame 103 to allow the diaphragm 101 to vibrate in a direction vertical to the frame 103 (Z-axis direction). Note that, the connection portion 102 is sometimes generally referred to as “edge”, “suspension”, “surround”, or the like. However, the term “connection portion” is used in this application.

In this embodiment, the connection portion 102 includes the same material as the diaphragm 101 and is integral with the diaphragm 101. The cross section of the diaphragm 101 is approximately semicircle as shown in FIG. 2. Furthermore, as a material of the connection portion 102, elastomer other than a material of the diaphragm 101 may be used to lower a low frequency limit. When the connection portion 102 and the diaphragm 101 are made from mutually different materials, for example, the connection portion 102 and the diaphragm 101 are formed separately to be adhered with each other later or the connection portion 102 is formed integrally with the diaphragm 101 by using an insert molding technique or the like.

As shown in FIG. 2, the magnetic circuit 120 is disposed in the frame 103, and the frame 103 is an open-topped frame. Furthermore, lower sides of outer end portions of the connection portion 102 are fixed to the frame 103.

The cover member 104 is disposed to be connected to one end of the frame 103 and to cover the diaphragm 101 from the above. The one end is in a lateral direction (the X-axis direction in this embodiment) that is orthogonal to the vertical direction.

In this embodiment, the cover member 104 is fixed to an upper side of one of outer end portions of the connection portion 102. In other words, the cover member 104 is connected to one end of the frame 103 in the lateral direction (the left end in FIG. 2) through the one of the outer end portions of the connection portion 102.

Stated differently, out of two portions of the connection portion 102 which extend in the longitudinal direction of the diaphragm 101, the cover member 104 is (i) fixed along an outer end portion on one side (on the left in FIG. 2) and (ii) not fixed, at least partly, to an outer end portion on another side (on the right in FIG. 2) of the connection portion 102. Thus, an opening 130 (hereinafter also referred to as a “sound hole”) for emitting a sound in the direction orthogonal to the vibration direction of the diaphragm 101 (lateral direction) is formed.

The magnet 105, the plate 106, and the yoke 107 are included in the magnetic circuit 120 that is of an internal magnetic type. The magnetic circuit 120 creates magnetic flux in a magnetic gap G formed between the plate 106 and an inner wall of the yoke 107. Specifically, in the magnetic circuit 120, the magnet 105 is fixed to a bottom face of the yoke 107, and the plate 106 is fixed to a top face of the magnet 105.

Furthermore, the magnet 105, the yoke 107, and the diaphragm 101 are arranged such that (i) the directions of the longitudinal directions of the magnet 105, the yoke 107, and the diaphragm 101 coincide with one another and (ii) the central axes of the magnet 105, the yoke 107, and the diaphragm 101 approximately coincide with one another. Consequently, the magnetic gap G is formed between the rectangular shaped plate 106 and the side face of the yoke 107.

The shape of each of the magnet 105 and the plate 106 as seen from the top is rectangular. The yoke 107 has a U-shaped cross section as shown in FIG. 2.

A material of the magnet 105 may be a neodymium magnet, a samarium cobalt magnet, or the like according to a target sound pressure, shape and the like. Furthermore, in this embodiment, the yoke 107 is fixed to the frame 103.

The voice coil bobbin 108 is fixed to the diaphragm 101, and applies force to the diaphragm 101. The shape of the voice coil bobbin 108 as seen from the top is rectangular. The voice coil bobbin 108 is obtained by forming, for example, a paper, aluminum foil, a polymeric resin film such as polyimide, or the like into a desired shape. The voice coil bobbin 108 is fixed to the diaphragm 101 such that (i) the directions of the longitudinal directions of voice coil bobbin 108 and the diaphragm 101 coincide with each other, and (ii) the central axes of the voice coil bobbin 108 and the diaphragm 101 approximately coincide with each other.

The voice coil 109 is supported by the voice coil bobbin 108 so as to be placed in the magnetic gap G of the magnetic circuit 120. The shape of the voice coil 109 as seen from the top is rectangular. The voice coil 109 includes a winding of a conductor such as copper or aluminum. The voice coil 109 is fixed so as to adhere to a side face of the voice coil bobbin 108.

The spacer 110 is, as shown in FIG. 2, positioned on the side opposite to the opening 130 that is the side where the cover member 104 is fixed to the connection portion 102 (hereinafter referred to as a “closed end side”), and the spacer 110 is bonded to a bottom face of the cover member 104. Furthermore, the spacer 110 is prepared, for example, by molding a resin.

With the spacer 110, it is possible to reduce impact on the sound pressure frequency characteristics of the speaker 100 attributed to the acoustic load on the closed end side in the space between the cover member 104 and the diaphragm 101. Advantageous effects of the spacer 110 will be described later.

The operation of the speaker 100 having the above-described structure shall be described.

When a current is applied to the voice coil 109, driving force is generated by the voice coil 109 due to the applied current and the magnetic field generated in the magnetic gap G. The generated driving force is transmitted to the diaphragm 101 via the voice coil bobbin 108.

In other words, the generated driving force causes the diaphragm 101, the voice coil bobbin 108, and the voice coil 109 to perform the same vibration movement. The sound generated by the vibration of the diaphragm 101 passes through the space between the cover member 104 and the diaphragm 101. Then the sound is emitted to a space through the sound hole (the opening 130) that is provided in the direction orthogonal to the vibration direction of the diaphragm 101 with respect to the cover member 104.

The sound pressure frequency characteristics of the speaker 100 are described with a sound pressure simulation analysis using an acoustic equivalent circuit.

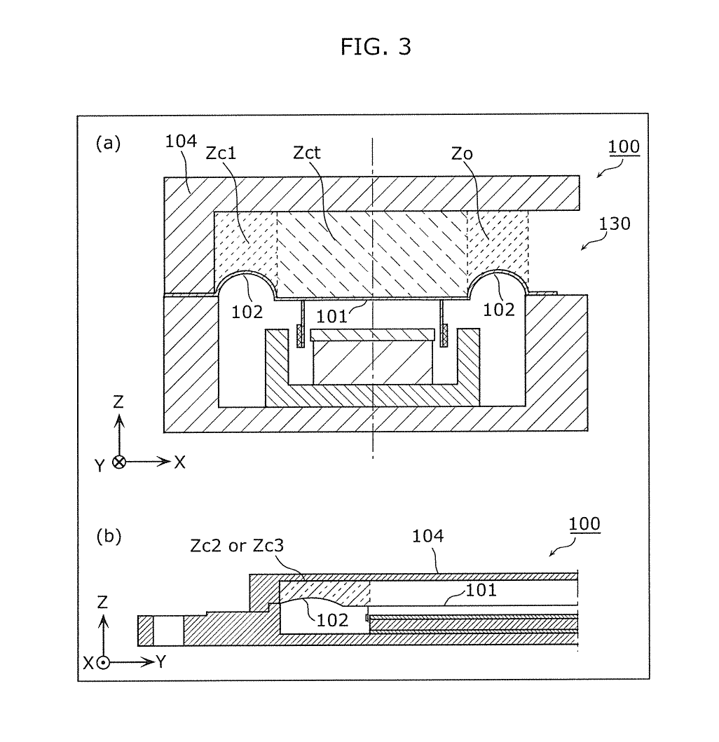

FIG. 3 is a schematic view showing a structure of the acoustic load of the speaker 100 according to Embodiment 1.

Specifically, (a) in FIG. 3 shows a structure of the acoustic load of the speaker 100 in the lateral direction, and (b) in FIG. 3 shows a structure of the acoustic load of the speaker 100 in the longitudinal direction. Note that an illustration of the spacer 110 is omitted in FIG. 3.

For the sake of qualitative behavior verification and planning of a solution, it is assumed that the acoustic load portion above the diaphragm 101 of the speaker 100 is divided into three acoustic loads of Zct, Zc1, and Zo as shown in (a) in FIG. 3.

The acoustic load Zct is, as shown in (a) in FIG. 3, a space from one of left and right inner end portions of the connection portion 102 of the diaphragm 101 to the other of left and right inner end portions of the connection portion 102, and is an acoustic load of a tubular portion with both ends open between the diaphragm 101 and the cover member 104.

The acoustic load Zc1 is, as shown in (a) in FIG. 3, a space between the inner end portion of the connection portion 102 fixed to the cover member 104 and an inner wall of the cover member 104 on the closed end side, and is an acoustic load of a closed tubular portion with one side completely closed between the diaphragm 101 and the cover member 104.

The acoustic load Zo is, as shown in (a) in FIG. 3, a space between the inner end portion of the connection portion 102 on the side where the opening 130 that is the sound hole is formed and the outer end portion, and is an acoustic load of an open tubular portion in a sound emitting direction between the diaphragm 101 and the cover member 104.

It is considered that, out of a space between the diaphragm 101 and the cover member 104 shown in (b) in FIG. 3, two acoustic loads Zc2 and Zc3 that represents spaces at both ends in the longitudinal direction are connected to the acoustic load Zc1.

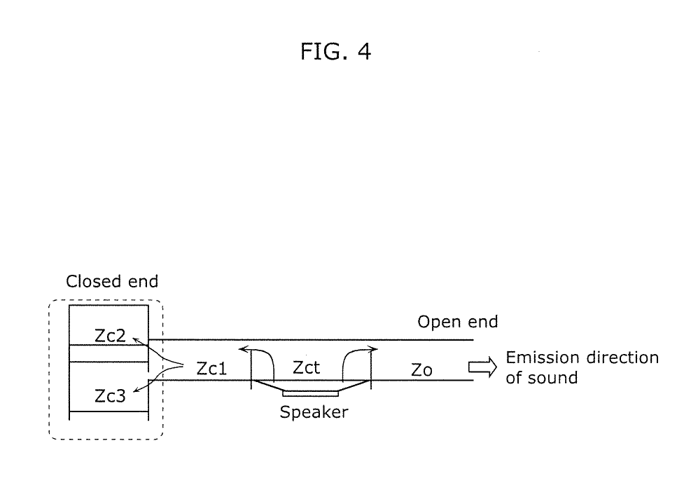

FIG. 4 is a schematic view of a structure of the acoustic tube formed by each of the acoustic loads shown in FIG. 3.

An impedance Z of the acoustic tube is expressed by a matrix (Expression 1). In (Expression 1), S denotes a cross sectional area of the acoustic tube, I denotes a length of the acoustic tube, and ρ0 denotes a density of air, c denotes a speed of sound, and k denotes a wave number (2nf/c).

$$\begin{matrix}[ Math 1 ] & \\ Z = [ \begin{matrix}- j \frac{{ρ}_{0} c}{S} cot kl & j \frac{{ρ}_{0} c}{S} \frac{1}{sin kl} \\ j \frac{{ρ}_{0} c}{S} \frac{1}{sin kl} & - j \frac{{ρ}_{0} c}{S} cot kl\end{matrix} ] & ( Expression 1 )\end{matrix}$$

Impedance is calculated for each of Zct, Zc1, Zo, Zc2, and Zc3 according to (Expression 1), and an acoustic equivalent circuit of an acoustic tube shown in FIG. 4 is formed to perform sound pressure simulation. The result is as follows.

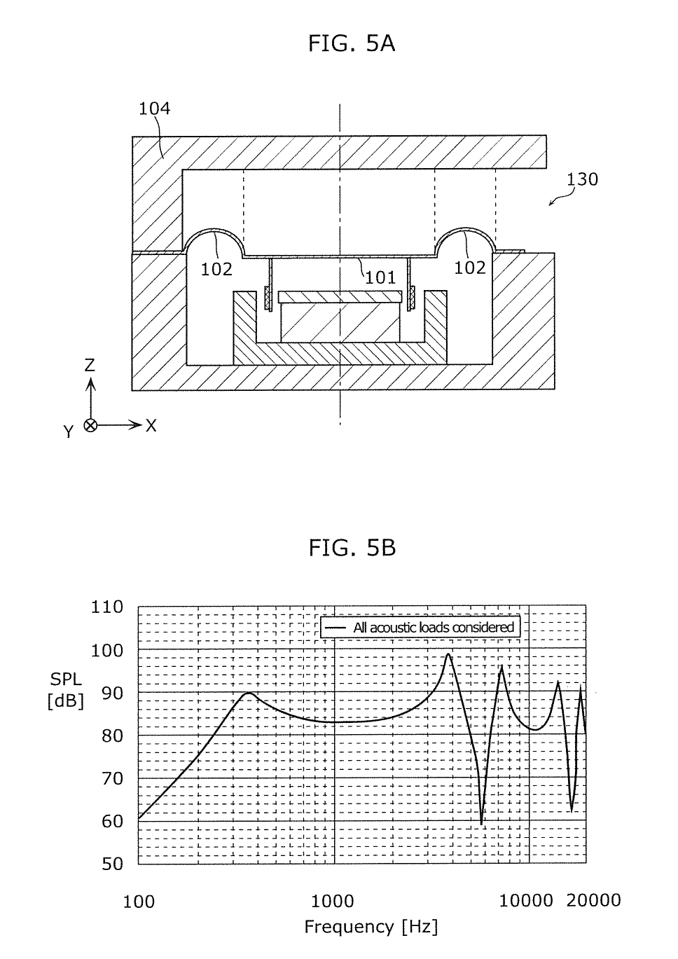

FIG. 5A is a cross-sectional view taken along A-A′ of the speaker 100 which does not include the spacer 110, and is a diagram showing a simulation analysis model in the case where all of the acoustic loads are taken into consideration.

FIG. 5B is a diagram showing an analysis result of a simulation of an acoustic equivalent circuit in the case where all of the acoustic loads are taken into consideration.

In other words, FIG. 5B shows an analysis result obtained with an initial condition which takes all of the acoustic loads into consideration, that is, the analysis result of a sound pressure simulation obtained using an acoustic equivalent circuit shown in FIG. 5A which does not include the spacer 110.

Furthermore, FIG. 5B shows sound pressure frequency characteristics obtained, when power of 1 W is inputted to the speaker 100, at a position that is 1 m away from the speaker 100 and on an axis which passes the center of the speaker 100 and points a direction in which a sound is emitted from the speaker 100.

When the speaker 100 has a structure shown in FIG. 5A, as shown in FIG. 5B, peak/dip in the lowest frequency attributed to the acoustic load in the space above the diaphragm 101 (hereinafter also referred to as a “space above the diaphragm”) appears approximately between 3 kHz to 10 kHz in the sound pressure frequency characteristics.

To move a resonance frequency attributed to the acoustic load to a high frequency direction, an acoustic compliance may be decreased. In other words, volumetric capacity inside the acoustic tube may be reduced.

Here, it is assumed that the sound hole (the opening 130) side at which a sound is directly emitted is not so much affected by the acoustic loads, and the closed end side at which the sound reflects or so on is greatly affected by the acoustic loads.

Then, as an ideal state, an acoustic equivalent circuit is formed using impedances that are calculated assuming that the closed end portion does not exist.

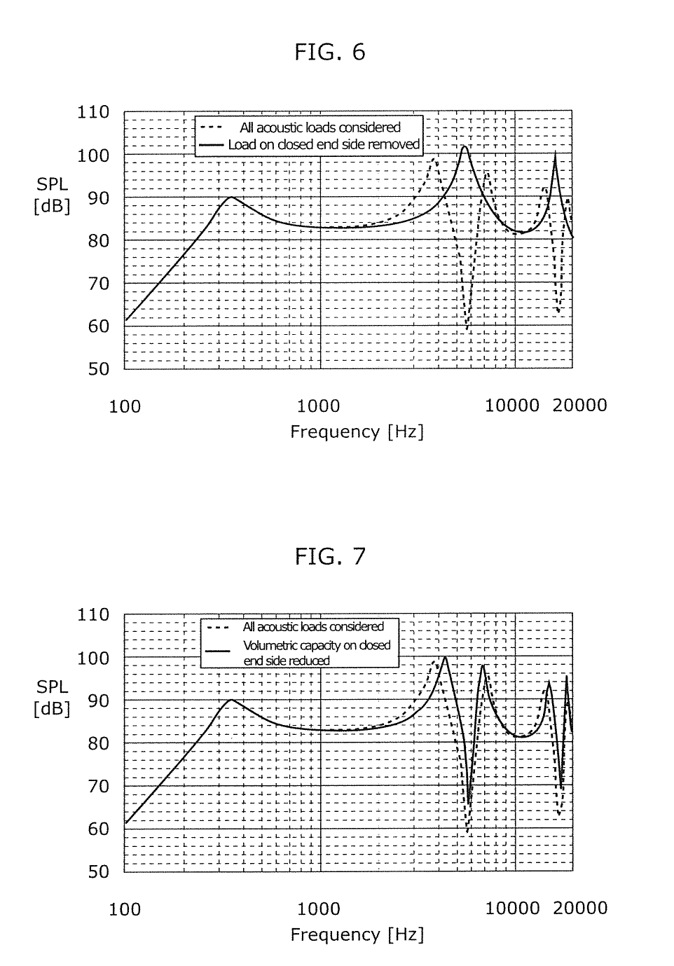

FIG. 6 is a diagram showing an analysis result of a simulation in the case where the acoustic load on the closed end side does not exist.

In other words, FIG. 6 is a diagram showing an analysis result of the sound pressure simulation in the ideal state.

In FIG. 6, the dotted line shows analysis result when all of the acoustic loads are taken into consideration shown in FIG. 5B, and the solid line shows analysis result obtained with the ideal state.

According to FIG. 6, in the ideal state in which closed end portion does not exist, it is confirmed that resonance frequency in high frequency is moved to a higher frequency and occurrence of the dip is suppressed.

The above shows that the impact of the acoustic load on the closed end side on the sound pressure frequency characteristics is significant.

However, the diaphragm 101 needs to vibrate vertically. Thus, the volumetric capacity of the space on the closed end side cannot be eliminated, and an approach to reducing the volumetric capacity on the closed end side as much as possible is necessary.

In view of this, the inventors of the present application analyzed the case in which the volumetric capacity of the space of the acoustic load Zc1 is reduced by taking into consideration the vibration of the connection portion 102 of the diaphragm 101 on the closed end side.

FIG. 7 is a diagram showing an analysis result of a sound pressure simulation using an acoustic equivalent circuit in the case where the volumetric capacity of the space of the acoustic load Zc1 is reduced to 90%.

In FIG. 7, the dotted line shows the analysis result when all of the acoustic loads are taken into consideration, and the solid line shows analysis result when the volumetric capacity is reduced.

FIG. 7 shows that the resonance frequency is moved to a high frequency, when the volumetric capacity of the space on the closed end side is reduced. This indicates that the peak/dip is improved.

In view of this, in the speaker 100 according to this embodiment, the spacer 110 for reducing the volumetric capacity of the space above the diaphragm 101 and below the cover member 104 is provided on the closed end side.

Specifically, as shown in FIG. 2, the spacer 110 in this embodiment is provided on a bottom face of the cover member on the closed end side, the spacer 110 projecting downward.

The spacer 110 reduces the length in the amplitude direction of the diaphragm 101 in the space above the diaphragm on the closed end side. Consequently, the volumetric capacity in the space above the diaphragm on the closed end side is reduced.

The range of the volumetric capacity of the space above the diaphragm on the closed end side that can be reduced depends on the maximum amplitude of the diaphragm 101 and the size of the connection portion 102. For example, the spacer 110 is designed such that the cross sectional area in the lateral direction of the space above the diaphragm on the closed end side is 0.9 times the cross sectional area of the case without the spacer 110.

With this structure, the resonance frequency moves to high frequency by approximately 10% than the case without the spacer 110, and the dip rises by approximately 3 dB.

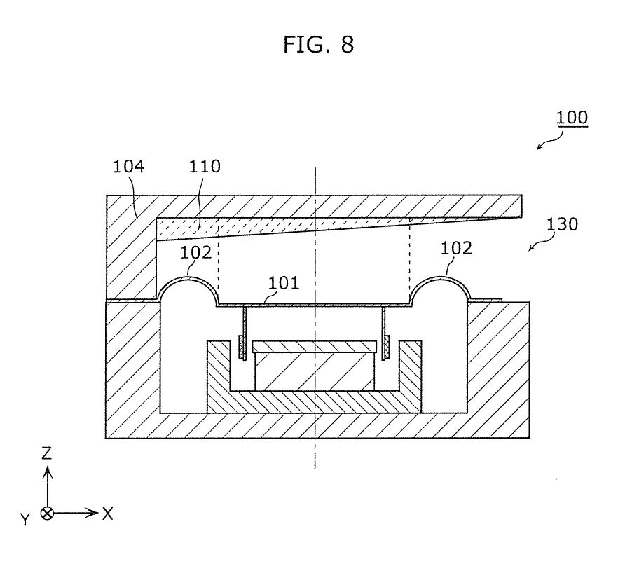

Note that, as shown in FIG. 8, the spacer 110 may be tapered such that the space between the diaphragm 101 and the cover member 104 spread from the closed end side toward the opening side. In other words, the spacer 110 may be formed such that a thickness of the spacer in the vertical direction decreases from the closed end side toward the opening 130.

The sound generated due to the vibration of the diaphragm 101 passes through the space above the diaphragm, and then emitted through the opening 130 that is a sound hole. Between the sound generated in the vicinity of the closed end side and the sound generated in the vicinity of the opening 130, the distances of the space through which the respective sound travels before being emitted from the opening 130 are different. Thus, a phase difference occurs. However, when the spacer 110 is tapered from the closed end side toward the opening 130 side, the difference between the distances is decreased, and thus disturbance in characteristic resulted from the dip or the like attributed to the phase difference is suppressed.

Furthermore, in the above, the spacer 110 and the cover member 104 are separate units. However, the spacer 110 and the cover member 104 are not limited to such an example, but may be formed integrally. In other words, a projection having a shape like the spacer 110 may be formed on the bottom face of the cover member 104 on the closed end side. Furthermore, the bottom face of the cover member 104 may be tapered like the taper shown in FIG. 8.

Next, the conditions to be satisfied by the diaphragm 101 are described.

When using the speaker, such as the speaker 100, in which the sound is emitted in the direction orthogonal to the vibration direction of the diaphragm, the sound pressure level tends to decrease in high frequency due to the directionality.

The directionality of the speaker is influenced by the effective vibration radius of the diaphragm. The practical threshold frequency according to a deterioration of the directionality is calculated according to (Expression 2). In (Expression 2), “a” denotes the effective vibration radius of the diaphragm.

$$\begin{matrix}[ Math 2 ] & \\ f \leq 3 ( \frac{c}{2 π a} ) & ( Expression 2 )\end{matrix}$$

As a condition of the effective vibration radius of the diaphragm, (Expression 2) is transformed into (Expression 3). Each symbol in (Expression 3) is identical to the corresponding one of the symbols in (Expression 1) and (Expression 2).

$$\begin{matrix}[ Math 3 ] & \\ a \leq 3 ( \frac{c}{2 π f} ) & ( Expression 3 )\end{matrix}$$

According to (Expression 3), for example, the effective vibration radius “a” of the diaphragm needs to be approximately 8 mm or less in order to maintain, up to 20 kHz, the tolerable sound pressure level considering a practical use.

In the speaker 100 according to this embodiment, the diaphragm 101 is in an elongated shape such as the shape shown in (a) in FIG. 1. The effective vibration length in a minor axis direction of the diaphragm 101 that is a direction (lateral direction) that is parallel to the direction from the closed end side toward the sound hole (the opening 130) is set so as to satisfy the condition according to (Expression 4).

With this structure, the speaker 100 can keep, up to a desired frequency “f”, the decrease in the sound pressure level attributed to the deterioration in directionality within a tolerable range. In (Expression 4), ds denotes the effective vibration length of the diaphragm, and other symbols are identical to the corresponding symbols in (Expression 1), (Expression 2), and (Expression 3).

$$\begin{matrix}[ Math 4 ] & \\ {d}_{s} \leq 3 ( \frac{c}{π f} ) & ( Expression 4 )\end{matrix}$$

On the speaker 100, considering (i) the desired size, such as the minor axis direction width of the chassis, an overlap width of the connection portion 102, a chassis fitting dimension, and (ii) characteristics such as a desired sound pressure, and f0 (lowest resonance frequency), it is found that the optimal effective vibration length of the diaphragm 101 in the minor axis direction (lateral direction) is less than or equal to 16 mm. It is more preferable that the effective vibration length in the minor axis direction be about 11 mm.

As described, it is possible to decrease the thickness of the speaker 100 and achieve flatter sound pressure frequency characteristics in the main band that includes high frequency than the conventional speaker, by using the spacer 110 that reduces the volumetric capacity of the space above the diaphragm on the closed end side.

### Embodiment 2

The following describes a speaker 200 according to Embodiment 2.

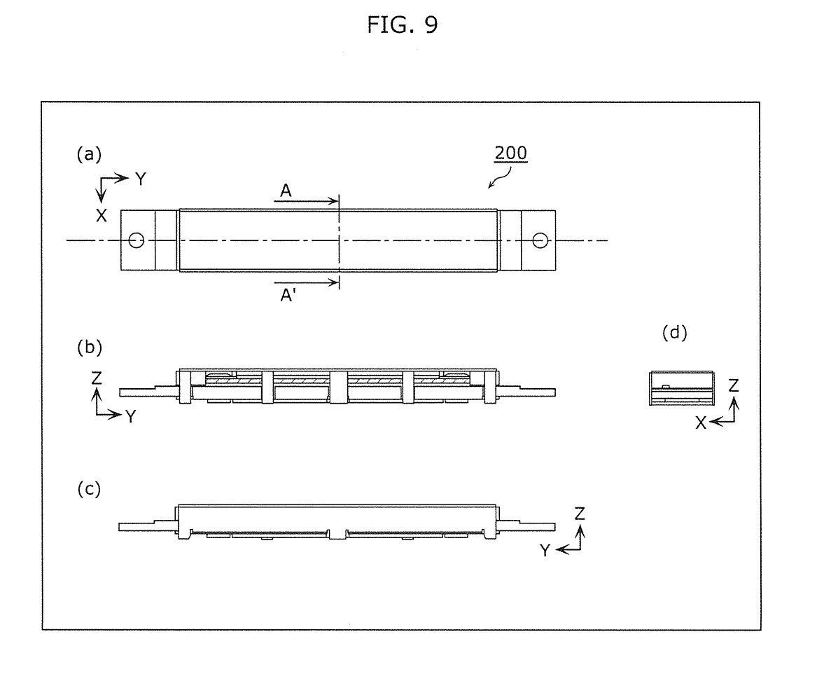

FIG. 9 is a diagram showing a configuration outline of the speaker 200 according to Embodiment 2.

Shown in (a), (b), (c), and (d) in FIG. 9 are a top view, an elevation view, a rear view, and a right lateral view of the speaker 200, respectively.

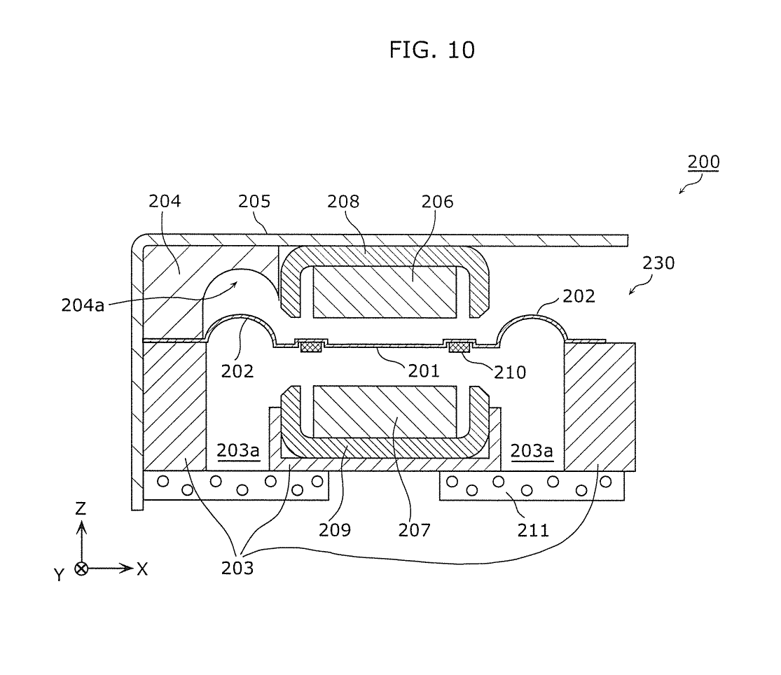

FIG. 10 is a magnified view of the A-A′ cross section of the speaker 200 according to Embodiment 2.

As shown in FIG. 10, the speaker 200 includes: a diaphragm 201 which includes connection portion 202; a frame 203; a spacer 204; a cover member 205; magnets 206 and 207 that are polarized opposite to each other; yokes 208 and 209; a voice coil 210; and a damping cloth 211. The speaker 200 is different from the speaker 100 according to Embodiment 1 mainly in the following five points.

(1) A magnetic circuit 220 of the speaker 200 includes: the magnets 206 and 207 arranged above and below the diaphragm 201, respectively; and the yokes 208 and 209 arranged above and below the diaphragm 201, respectively.

(2) The cover member 205 of the speaker 200 is fixed to the yoke 208, covers and surrounds the frame 203 and the spacer 204, and attached to the frame 203.

(3) The speaker 200 does not include a voice coil bobbin, and the voice coil 210 is directly bonded to the diaphragm 201.

(4) The damping cloth 211 is fixed to the bottom face of the frame 203.

(5) The spacer 204 includes a recess 204a on a surface facing the connection portion 202.

In this embodiment, as shown in FIG. 10, the recess 204a is formed on the spacer 204 by providing, to the spacer 204, a depression having a shape approximately similar to the upward projected shape of the connection portion 202. Note that, the “shape approximately similar” is a concept that also includes the shape completely similar.

Here, it is sufficient that the shape of the recess 204a be such that the connection portion 202 does not come into contact with the spacer 204, when the connection portion 202 reaches the maximum amplitude in the vertical direction due to the vibration of the diaphragm 201. For example, when the cross section shape of the connection portion 202 is approximately semicircle, a groove having a V-shaped cross section may be provided on the spacer 204 as the recess 204a.

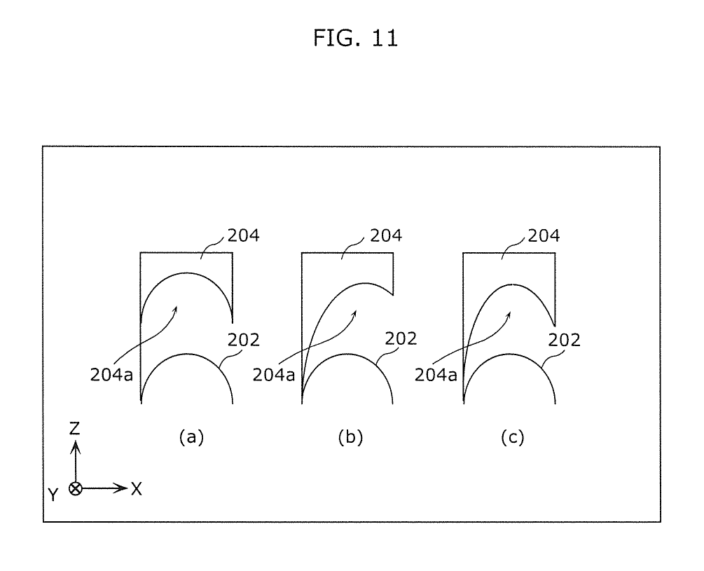

FIG. 11 is a diagram showing examples of various shapes of the spacer 204 according to Embodiment 2.

The recess 204a of the spacer 204 may have, for example, a shape obtained by offsetting the shape of the connection portion 202 as shown in (a) in FIG. 11.

Furthermore, the recess 204a of the spacer 204 may have, for example, a shape that is a portion of a curve of second order which takes into consideration the change in shape due to the vibration of the connection portion 202 as shown in (b) and (c) in FIG. 11.

Here, it is assumed that the recess 204a has a shape that is exactly like the half of a parabola, and an extreme value of the curve of second order is positioned right over the inner end portion of the connection portion 202. In addition, in this case, the bottom face of the spacer 204 (i.e., the inner face of the recess 204a) is tapered. Consequently, as is also described in Embodiment 1, an advantageous effect is produced, that is, the occurrence of the dip in characteristics attributed to the phase difference is suppressed. The phase difference occurs because, between the sound emitted from the closed end side of the diaphragm 201 and the sound emitted from an opening side (opening 230 side), the distances of space through which the respective sound travels before being emitted from the opening 230 are different.

Furthermore, for example as shown in (c) in FIG. 11, it is possible to further reduce the volumetric capacity of the space above the diaphragm on the closed end side, by increasing the thickness of the spacer 204 in the position of the inner end portion of the connection portion 202.

The following describes a structure of the speaker 200 with reference to FIG. 10.

The diaphragm 201 is connected to the frame 203 with the connection portion 202 to allow the diaphragm 201 to vibrate in a direction vertical to the frame 203. Furthermore, the diaphragm 201 is disposed in a floating-like state between the upper portion and the lower portion of the magnetic circuit 220 that includes the magnets 206 and 207 arranged above and below the diaphragm 201, respectively, and the yokes 208 and 209 arranged above and below the diaphragm 201, respectively.

The magnetic circuit 220 is fixed to the cover member 205 in the upper side and fixed to the frame 203 in the lower side.

An overlap width portion on an outer side of the connection portion 202 is sandwiched between the frame 203 and the spacer 204.

The cover member 205 is disposed to be connected to one end of the frame 203 in the lateral direction (X-axis direction) and to cover the diaphragm 201 from above. More specifically, the cover member 205 is attached to the frame 203, for example, by swage so as to cover the frame 203 and the spacer 204.

The voice coil 210 is rectangular shaped as seen from above, and includes a winding of a conductor such as copper or aluminum. The voice coil 210 is bonded to the lower side of the diaphragm 201 using, for example, an adhesive such that the voice coil 210 is concentric with the magnets 206 and 207.

On the bottom face of the frame 203, bottom face holes 203a, which are for releasing the sound emitted toward the bottom face, are provided. The damping cloth 211 is attached to cover the bottom face holes 203a. Instead of attaching the damping cloth 211, air permeability may be adjusted by attaching a member which includes a number of holes of small diameter.

Next, the operation of the speaker 200 shall be described.

In a state in which the voice coil 210 receives no input of an alternating electrical signal, magnetic flux radiated from the magnets 206 and 207 repel each other. Consequently, a vector of the magnetic flux bends approximately perpendicularly, and a magnetic field that includes a magnetic flux perpendicular to the vibration direction is formed.

When the alternating electrical signal is inputted to the voice coil 210, driving force is generated in a direction perpendicular to each of the direction of the current flowing in the voice coil 210 and the direction of the magnetic flux. Due to the driving force, the diaphragm 201 vibrates, and the vibration is emitted as a sound.

The sound emitted by the diaphragm 201 passes through the space above the diaphragm, and emitted through the sound hole (the opening 230) which is on a side and provided between the frame 203 and the cover member 205. The space above the diaphragm is formed by (i) the spacer 204, (ii) the portion of the magnetic circuit 220 above the diaphragm 201, made up of the magnet 206 and the yoke 208, and (ii) the diaphragm 201.

Here, inventors of the present application conducted an examination using a boundary element method (BEM) which includes an actual model shape so as to perform more accurate sound pressure characteristics simulation.

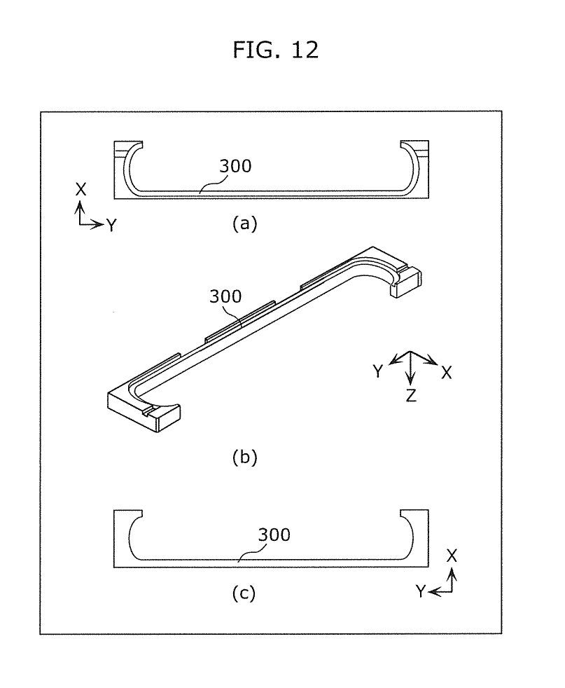

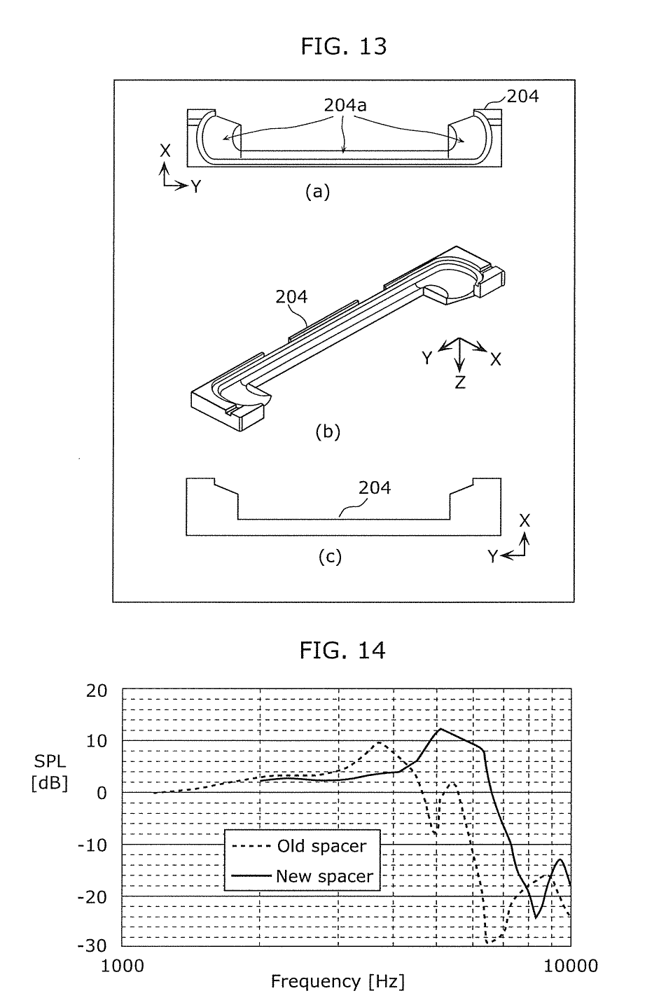

FIG. 12 is a diagram showing an example of an external appearance of a conventional spacer 300. FIG. 13 is a diagram showing an external appearance of the spacer 204 according to Embodiment 2.

Shown in (a), (b), and (c) in FIG. 12 are a bottom view, a perspective view, and a top view of the conventional spacer 300, respectively. Furthermore, (a), (b), and (c) in FIG. 13 are a bottom view, a perspective view, and a top view of the spacer 204, respectively.

The shape of the spacer 204 according to Embodiment 2 is more effective in flattening the sound pressure frequency characteristics because the spacer 204 includes the recess 204a. Specifically, in a range that the vibration does not cause the diaphragm 201 to contact the magnetic circuit 220, the spacer 204 has a shape which allows the volumetric capacity of the space above the diaphragm to be minimized. The space above the diaphragm is formed by (i) the spacer 204, (ii) the portion of the magnetic circuit 220 above the diaphragm 201, made up of the magnet 206 and the yoke 208, and (ii) the diaphragm 201.

FIG. 14 is a diagram showing results of the BEM simulation of the conventional spacer 300 and the spacer 204 according to Embodiment 2.

In FIG. 14, the dotted line shows sound pressure frequency characteristics of the speaker 200 which includes the conventional spacer 300 (described as an “old spacer” in FIG. 14), and the solid line shows sound pressure frequency characteristics of the speaker 200 which includes the spacer 204 (described as a “new spacer” in FIG. 14). Furthermore, in FIG. 14, a vertical axis is normalized with 80 dB as 0 dB.

FIG. 14 shows that, the peak/dip frequency is moved to high frequency by reducing, with the spacer 204, the volumetric capacity of the space above the diaphragm on the closed end side in the speaker 200. Furthermore, FIG. 14 shows that the dip is also improved (amount of the dip is reduced).

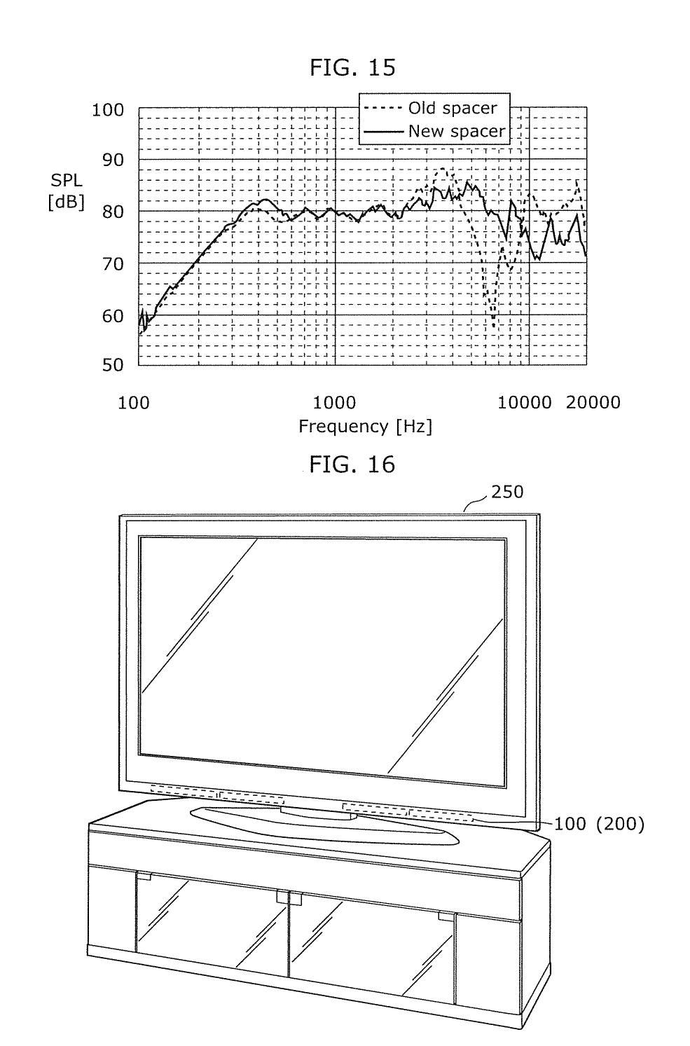

Next, FIG. 15 shows measured characteristics of a prototype designed based on the result of the BEM simulation.

FIG. 15 is a diagram showing sound pressure frequency characteristics of the prototype of the speaker 200 according to Embodiment 2.

Specifically, FIG. 15 shows sound pressure frequency characteristics obtained, when power of 1 W is inputted to the speaker 200, at a position that is 1 m away from the speaker 100 and on an axis which passes the center of the speaker 100 and points a direction in which a sound is emitted from the speaker 100.

Furthermore, in FIG. 15, the dotted line shows sound pressure frequency characteristics when the conventional spacer 300 is disposed in the speaker 200, and the solid line shows sound pressure frequency characteristics when the spacer 204 according to Embodiment 2 is disposed in the speaker 200.

As shown in FIG. 15, the measurement also indicates that the impact of the peak/dip on the main band is suppressed with the spacer 204 according to Embodiment 2.

As described, it is possible to decrease the thickness of the speaker 200 and achieve flattening of sound pressure frequency characteristics in the main band that includes high frequency, by using the spacer 204 that reduces the volumetric capacity of the space above the diaphragm on the closed end side.

Furthermore, by using the spacer 204 which (i) takes into consideration the vibration of the diaphragm 201 and the deformed shape at the maximum amplitude, and (ii) allows the volumetric capacity of the space above the diaphragm on the closed end side to be as small as possible, it is possible to achieve even more flatter sound pressure frequency characteristics in the main band including high frequency, while decreasing the thickness of the speaker 200.

Furthermore, both the speaker 100 according to Embodiment 1 and the speaker 200 according to Embodiment 2 can be included in acoustic equipment as sound output devices.

For example, each of the speakers 100 and 200 can be included, as a sound output device, in acoustic equipment such as a television (i) in which an emission opening of a sound cannot be disposed in a large area in a front face that faces a user, and (ii) which requires flat sound pressure frequency characteristics in the main band.

FIG. 16 is a diagram showing an external appearance of a television 250 which includes one of the speaker 100 according to Embodiment 1 and the speaker 200 according to Embodiment 2.

The television 250 shown in FIG. 16 is an example of acoustic equipment which includes the speaker according to the present invention.

Note that although the television 250 includes the four speakers 100 (200) in FIG. 16, the number of the speaker 100 (200) included in the television 250 is not particularly limited.

Furthermore, although the television 250 in FIG. 16 includes the four speakers 100 (200) that are arranged below the screen, the position of the speakers is also not particularly limited. For example, one or more of the speakers 100 (200) may be disposed on the side of the screen so that the longitudinal direction of the speaker lies in a vertical direction.

Moreover, the speaker 100 and the speaker 200 may be arranged together.

Furthermore, the acoustic equipment which includes the speaker according to the present invention is not limited to the television. For example, acoustic equipment such as stereo sets may include the speaker according to the present invention.

The speaker and according to an implementation of the present invention have been described thus far based on Embodiments 1 and 2. However, the present invention is not limited to the above description. The scope of the present invention includes various modifications to one of Embodiment 1 and Embodiment 2 that may be conceived by those skilled in the art or forms constructed by combining structural elements described above, which do not depart from the essence of the present invention.

For example, the spacer 110 in Embodiment 1 may include a recessed shape similar to the recess 204a in Embodiment 2. In this case, the speaker 100 in Embodiment 1 can minimize the volumetric capacity of the space above the diaphragm on the closed end side while preventing the spacer 110 from contacting the connection portion 102 of the diaphragm 101, as with the speaker 200 according to Embodiment 2.

Furthermore, for example, the spacers 110 and 204 do not have to have solid structures. In other words, the spacers 110 and 204 may be hollow as long as the shape and the size of the spacers are such that the space above the diaphragm on the closed end side can be reduced.

### INDUSTRIAL APPLICABILITY

A speaker according to the present invention is a thin speaker that can achieve flat sound pressure frequency characteristics in a main band and, for example, can be applied to acoustic equipment and the like which output sound.

Furthermore, the acoustic equipment according to the present invention is useful as a device with a function to output sound, for example, as a television and the like.

### REFERENCE SIGNS LIST

100, 200 Speaker
101, 201 Diaphragm
102, 202 Connection portion
103, 203 Frame
104, 205 Cover member
105, 206, 207 Magnet
106 Plate
107, 208, 209 Yoke
108 Voice coil bobbin
109, 210 Voice coil
110, 204 Spacer
120, 220 Magnetic circuit
130, 230 Opening
203a Bottom face hole
204a Recess
211 Damping cloth
250 Television
300 Conventional spacer

1. A speaker comprising:
a magnetic circuit which includes a magnet and a yoke and generates magnetic flux;
a frame in which the magnetic circuit is disposed, the frame being an open-topped frame;
a coil provided in a magnetic gap of the magnetic circuit;
a diaphragm connected to the coil and including a connection portion which connects the diaphragm and the frame to allow the diaphragm to vibrate in a direction vertical to the frame; and
a cover member which (i) is disposed to be connected to one end of the frame and to cover the diaphragm from above, and (ii) forms, between the cover member and another end of the frame, an opening for emitting a sound, the one and the other ends being in a lateral direction that is orthogonal to the vertical direction,
wherein the cover member includes, on a closed end side that is a side opposite to the opening, a spacer for decreasing an acoustic compliance on the closed end side above the diaphragm and below the cover member.

2. The speaker according to claim 1,
wherein the spacer is provided on a bottom face of the cover member on the closed end side, the spacer projecting downward.

3. The speaker according to claim 1,
wherein the connection portion is at least partly in an upward projected shape, and
the spacer includes a recess on a surface facing the connection portion.

4. The speaker according to claim 3,
wherein the recess is formed on the spacer by providing, to the spacer, a depression having a shape approximately similar to the upward projected shape of the connection portion.

5. The speaker according to claim 1
wherein the spacer is formed such that a thickness of the spacer in the vertical direction decreases from the closed end side toward the opening.

6. The speaker according to claim 1,
wherein, on the closed end side, the space above the diaphragm and below the cover member has a cross sectional area in the lateral direction less than or equal to 0.9 times a cross sectional area of the space without the spacer.

7. The speaker according to claim 1,
wherein the diaphragm has an effective vibration length less than or equal to 16 mm in the lateral direction.

8. An acoustic equipment comprising
the speaker according to claim 1,
wherein the acoustic equipment outputs a sound using the speaker.
